(19) United States
(12) Patent Application Publication
(10) Pub. No.: US 2022/0343192 A1
(43) Pub. Date: Oct. 27, 2022

(54) MANAGEMENT APPARATUS AND MANAGEMENT METHOD

(71) Applicant: Hitachi, Ltd., Tokyo (JP)

(72) Inventor: Yasutaka KONO, Tokyo (JP)

(73) Assignee: Hitachi, Ltd., Tokyo (JP)

(21) Appl. No.: 17/672,870

(22) Filed: Feb. 16, 2022

(30) Foreign Application Priority Data
Apr. 23, 2021 (JP) 2021-073660

(51) Int. Cl. G06N 5/04; G06K 9/62

(52) U.S. Cl. CPC G06N 5/04; G06K 9/6257

(57) ABSTRACT

A management apparatus includes operation influence information defining an influence a management operation exerts on a management target, a management operation log recording a management operation executed on the management target, and a management operation schedule indicating a management operation of which execution on the management target is planned or inferred; determines whether a difference between actual measurement monitoring data acquired from the management target and predicted monitoring data indicating a result of predicting the monitoring data exceeds a given threshold; defines the difference as a significant difference when the difference exceeds the threshold; determines whether the significant difference is temporary or perpetual, based on the operation influence information, management operation log, and management operation schedule; and when determining the significant difference to be perpetual, determines that retraining of a machine learning model should be executed.

### BACKGROUND OF THE INVENTION

### 1. Field of the Invention

The present disclosure relates to a technique for operating and managing a system utilizing machine learning.

### 2. Description of the Related Art

A device and a service that continuously maintain or improve the quality of a machine learning (ML) model through operation of a system utilizing ML has been in demand in recent years. A technique related to such a device and service is disclosed in US 20160371601 A1.

US 20160371601 A1 discloses a method by which whether a concept drift had occurred is determined, based on a result of continuous evaluation of the accuracy of a model, and when the occurrence of the concept drift has been determined, the model is relearned.

### SUMMARY OF THE INVENTION

Because the retraining method for the ML model disclosed in US 20160371601 A1 does not take into consideration the cause of the concept drift, the method raises a possibility that retraining does not always turn out to be a proper one. Retraining turns out to be improper one, for example, in the following cases: (1) unnecessary retraining takes unnecessary cost, (2) retraining rather reduces the accuracy, and (3) retraining timing is not proper, making extra cost necessary.

A problem will be discussed by taking up a specific example of management of an IT infrastructure utilizing ML. For example, a configuration is considered in which a certain data storage array includes a storage area (hereinafter, “pool”), a sub-storage area (hereinafter, “volume”) cut out from that storage area is allocated to a computer, and the computer performs data input/output (I/O) to/from the volume. It is assumed in this case that an ML model is provided, the ML model training past performance data (e.g., a busy rate or the like) on the pool by ML and predicting a future value of the pool. If the retraining method of US 20160371601 A1 is applied to this ML model, the model can be relearned when its degradation in quality is detected.

According to the retraining method for the ML model disclosed in US 20160371601 A1, however, the type of the concept drift cannot be distinctively identified, that is, whether the concept drift has been caused by a change in a tendency of I/O by a computer or by a management operation on a volume or a pool cannot be determined.

A case may be assumed, for example, where a flow of I/O from/to the computer to/from the volume does not change at all but performance load on the pool is increased by a data copy operation executed on the volume and consequently the concept drift is detected. When the data copy operation is a manually executed one-time operation, the increase in the performance load is not continuous, and therefore the ML model should not be relearned. However, the retraining method for the ML model disclosed in US 20160371601 A1 cannot distinctively identify such a case, thus allowing execution of retraining. As a result, the above cases (1) and (2) occur.

Another problem will be discussed using another example. It is assumed that a management operation is carried out to cut out a second volume from the above pool and allocate the second volume to a second computer. As a result of the management operation, I/O from/to the second computer newly flows to/from the pool, and consequently a concept drift is detected. In this case, according to the retraining method for the ML model disclosed in US 20160371601 A1, ML model retraining is carried out. Another case may also be assumed where when the existence of a discrepancy of a given or larger magnitude between a performance prediction value by the ML model and a performance actual measurement value observed later is recognized (that is, performance problem is recognized), IT management software or an IT administrator performs a management operation for eliminating the performance problem. For example, to lower the performance load on the pool to balance the pool with other pools in their performance load, an operation of transferring some volumes cut out from the pool to another pool may be carried out. When the IT management software or the IT administrator carries out this operation, it lowers the performance load on the pool. This case, therefore, may lead to the lower accuracy of pool performance prediction by the ML model relearned. As a result, according to the retraining method for the ML model disclosed in US 20160371601 A1, ML model retraining is carried out again, which is equivalent to the above case (3).

An object of the present disclosure is to provide a technique that enables proper retraining of a machine learning model.

A management apparatus according to one aspect included in the present disclosure includes a processor and a storage device, and comprises: a machine learning model generating unit that generates a machine learning model for inferring monitoring data acquired from a management target; an inference process unit that carries out an inference process using the machine learning model; a management unit that manages the management target using a result of the inference process; and a retraining necessity determining unit that determines whether retraining the machine learning model is necessary, the machine learning model generating unit, the inference process unit, the management unit, and the retraining necessity determining unit being each provided by the processor's executing a software program stored in the storage device. The management unit includes operation influence information defining an influence of a management operation on the management target, a management operation log recording a management operation executed on the management target, and a management operation schedule indicating a management operation of which execution on the management target is planned or inferred. The management unit determines whether a difference between actual measurement monitoring data that is monitoring data acquired from the management target and predicted monitoring data that is a result of an inference process of predicting monitoring data, the inference process being executed by an inference process unit, exceeds a given threshold. The retraining necessity determining unit defines the difference as a significant difference when the difference exceeds the threshold, determines whether the significant difference is temporary or perpetual, based on the operation influence information, the management operation log, and the management operation schedule, and when determining the significant difference to be perpetual, determines that retraining of the machine learning model should be executed.

An aspect of the present disclosure allows proper retraining of a machine learning model.

### BRIEF DESCRIPTION OF THE DRAWINGS

FIG. 1 is a block diagram of a configuration of a computer system;

FIG. 2 is a block diagram of a configuration example of a management computer;

FIG. 3 depicts an example of a management target table;

FIG. 4 depicts an example of a configuration information table;

FIG. 5 depicts an example of a management operation table;

FIG. 6 depicts an example of an operation influence table;

FIG. 7 is a flowchart of an example of a procedure of a monitoring process executed by an IT management program;

FIG. 8 is a flowchart of an example of a procedure of a retraining necessity determining process executed by a retraining necessity determining program;

FIG. 9 is a flowchart of an example of a procedure of a retraining process executed by a training program;

FIG. 10 is a conceptual diagram showing the state of correction of retraining data;

FIG. 11 depicts an example of a screen for displaying a result of retraining necessity determination;

FIG. 12 depicts another example of the screen for displaying the result of retraining necessity determination;

FIG. 13 depicts still another example of the screen for displaying the result of retraining necessity determination; and

FIG. 14 depicts still another example of the screen for displaying the result of retraining necessity determination.

### DESCRIPTION OF THE PREFERRED EMBODIMENTS

Embodiments will hereinafter be described with reference to the drawings. Embodiments described below do not limit the invention disclosed in the claims, and all constituent elements and combinations thereof described in the embodiments are not necessarily essential to solutions by the invention. In the drawings, the same reference numerals denotes the same constituent elements in a plurality of drawings. In the following description, pieces of information on the present invention will be described using such an expression as “aaa table”. These pieces of information, however, may be expressed in a data structure different from a table or the like. To indicate non-dependency on a specific data structure, therefore, “aaa table” or the like may be referred to as “aaa information”. When the contents of each piece of information are described, such terms as “identification information”, “identifier”, “name”, and “ID” are used. These terms are interchangeable.

In the following description, “program” is used as the subject in some cases. However, because a program run by a processor carries out a given process, using a memory and a communication port (communication device, a management I/F, a data I/F, etc.), the processor may be used as the subject in the description. A process described by using a program as the subject may be described as a process carried out by a computer or information processor, such as a server. Some or all of programs may be implemented by dedicated hardware. Various programs may be installed in each of computers by a program distribution server or a computer-readable storage medium.

Hereinafter, a set of one or more computers that manage a computer system and that display information-to-display of the present invention may be referred to as a management system. When a management computer displays the information-to-display, the management computer is equivalent to the management system. A combination of the management computer and a display computer is also equivalent to the management system. To achieve a faster and highly reliable management process, a plurality of computers may be put together to carry out the same process as the management computer carries out. In such a case, the plurality of computers (which include the display computer when the display computer is responsible for a display function) is equivalent to the management system.

### <<Embodiment>>

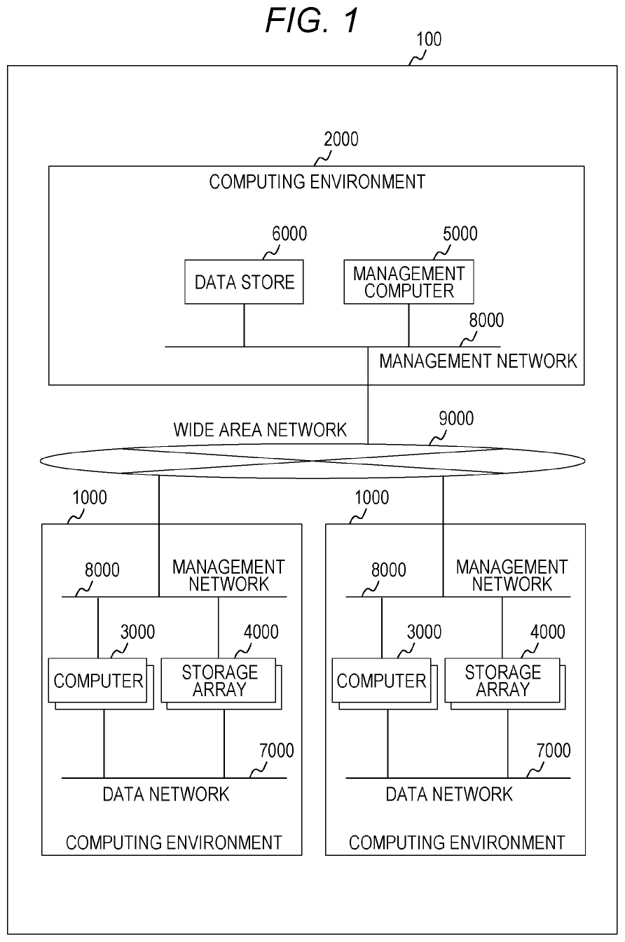

FIG. 1 is a block diagram of a configuration of a computer system according to an embodiment. A computer system 100 includes a plurality of computing environments. FIG. 1 shows the computer system 100 including computing environments 1000 and a computing environment 2000. FIG. 1 shows a configuration in which two computing environments 1000, which are management targets, are present. The configuration of the computer system is, however, not limited to this configuration. The computer system including at least one computing environment 1000 is applicable. The computing environment 1000 and the computing environment 2000 may be installed respectively in different geographical locations.

The computing environment 1000 includes a computer 3000, a storage array 4000, a data network 7000, and a management network 8000. The storage array 4000 may be a device having dedicated hardware, or may be provided as a program executed by a processor included in the computer 3000. The computer 3000 and the storage array 4000 may be provided in any form, such as a physical device, a virtual device, a container, or a managed service. Functions the computer 3000 and storage array 4000 have may be each executed on a different device, as a microservice. Different computers 3000, as well as different storage arrays 4000, are interconnected via the data network 7000, and so are the computer 3000 and the storage array 4000. The computer 3000 and the storage array 4000 are connected to a management computer 5000 and a data store 6000 of the computing environment 2000, via a management network 8000. In the example of FIG. 1, two computing environments 1000 have the same configuration, but their configuration is not limited to one shown in this example. In a different example, the two computing environments 1000 may have their respective configurations different from each other. The computing environment 1000 and the computing environment 2000 may be owned by different owners, respectively. In such a case, the owner of the computing environment 2000 may allow the owner of the computing environment 1000 to use calculation resources and functions of the computing environment 2000 in the form of a cloud service.

The computing environment 2000 includes the management computer 5000, the data store 6000, and a management network 8000. The management computer 5000 and the data store 6000 may be provided in any form, such as a physical device, a virtual device, a container, or a managed service. Functions the management computer 5000 and data store 6000 have may be each executed on a different device, as a microservice. The management computer 5000 and the data store 6000 are interconnected via the management network 8000.

The computing environment 1000 and the computing environment 2000 are interconnected via a wide area network 9000. In other words, the management network 8000 of the computing environment 1000 and the management network 8000 of the computing environment 2000 can communicate with each other via the wide area network 9000. The management computer 5000 of the computing environment 2000, therefore, can manage the computer 3000 and the storage array 4000 of the computing environment 1000 via the management network 8000. In addition, monitoring data (which is referred to also as metrics data) on the computer 3000 and storage array 4000 of the computing environment 1000 can be stored in the data store 6000 via the management network 8000. Metrics data include, but are not limited to, performance data on the computer 3000 and the storage array 4000, capacity data on calculation resources, and operating state data. In this embodiment, a program executed by a processor included in each of the computer 3000 and the storage array 4000 transmits metrics data on the computer 3000 and storage array 4000 to the data store 6000 to store the metrics data therein. A process of storing metrics data is, however, not limited to this. A specific program, for example, may be executed to cause a computer different from the computer 3000 and storage array 4000 connected to the management network 8000 of the computing environment 1000 to collect metrics data from the computer 3000 and the storage array 4000 and transmit the metric data to the data store 6000. In another case, for example, the management computer 5000 may collect metrics data on the computer 3000 and storage array 4000 via the management network 8000 and store the metrics data in the data store 6000.

The computer system 100 may be configured such that no computing environment 2000 is present in the computer system 100 and that the management computer 5000 and the data store 6000 are present in the computing environment 1000. The computer system 100 may also be configured such that no wide area network 9000 is present in the computer system 100 as only one computing environment 1000 is present therein and that the management computer 5000 and the data store 6000 are present in the one computing environment 1000. The wide area network 9000 may be, for example, the Internet or a dedicated line. In another case, the wide area network 9000 may be a virtual private network.

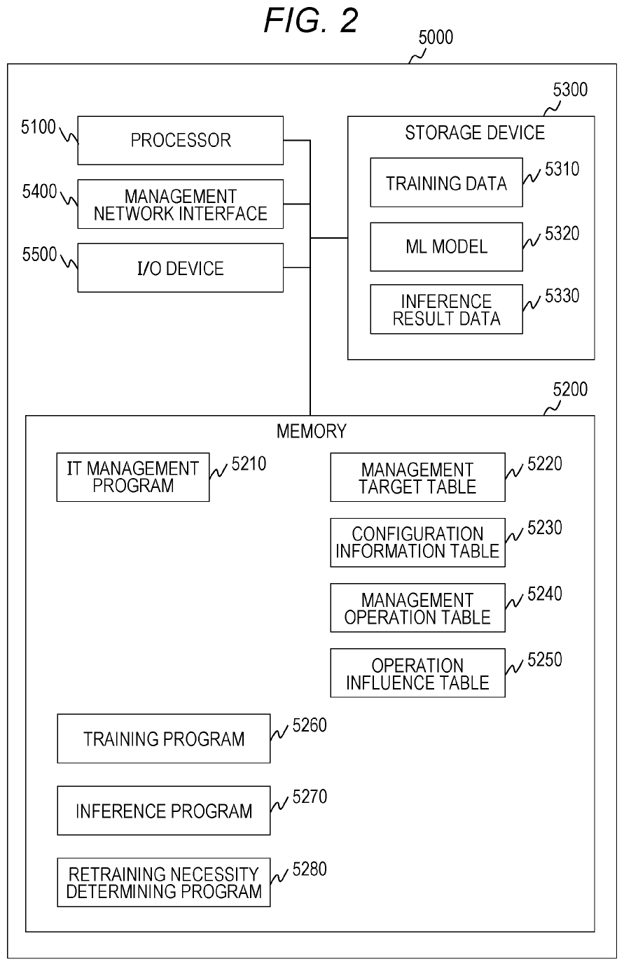

FIG. 2 is a block diagram of a configuration example of the management computer 5000 according to this embodiment. The management computer 5000 manages the computer 3000 and the storage array 4000 of the computing environment 1000. The management computer 5000 includes a processor 5100, a memory 5200, a storage device 5300, a management network interface 5400, and an input/output (I/O) device 5500. These constituent elements are connected to each other via a bus.

The management network interface 5400 is used for connection with the management network 8000.

The storage device 5300 is composed of a hard disk drive (HDD), a solid state drive (SSD), or the like. In this embodiment, the storage device 5300 stores therein training data 5310, an ML model 5320, and inference result data 5330. An IT management program 5210, a training program 5260, an inference program 5270, and a retraining necessity determining program 5280 are stored in the storage device 5300, but are read and loaded onto the memory 5200 and are executed by the processor 5100.

The memory 5200 is composed of, for example, a semiconductor memory. In this embodiment, the memory 5200 stores an IT management program 5210, the training program 5260, the inference program 5270, the retraining necessity determining program 5280, a management target table 5220, a configuration information table 5230, a management operation table 5240, and an operation influence table 5250. The management target table 5220, the configuration information table 5230, the management operation table 5240, and the operation influence table 5250 may be stored in the storage device 5300, in which case data in these tables are made permanent.

The training program 5260 is a program for generating the ML model 5320 for predicting a future value of metrics data, using the training data 5310 created from the metrics data stored in the data store 6000, the metrics data being acquired from the computer 3000 and the storage array 4000. For example, the training program 5260 can be provided using a known algorithm, such as Random Forest. However, an algorithm different from Random Forest, etc., may also be used as the training program 5260. Prediction of a future value of metrics data is generally known as a regression problem, and the ML model generated by the training program 5260 may be a model for dealing with the regression problem. Still, the ML model may also be a model for dealing with a problem different from the regression problem.

The inference program 5270 is a program for making an inference, using the ML model 5320, to generate the inference result data 5330. The inference mentioned here means prediction of a future value of metrics data on the computer 3000 and the storage array 4000. In this embodiment, the inference program 5270 is executed periodically by the processor 5100. The inference program 5270, however, may be executed not periodically but in different timing.

The IT management program 5210 is a program for managing the computer 3000 and the storage array 4000 of the computing environment 1000. In this embodiment, the IT management program 5210 has a function of identifying a performance problem with the computer 3000 or the storage array 4000 by comparing the inference result data 5330 generated by the inference program 5270 with metrics data on the computer 3000 and the storage array 4000, the metrics data being stored in the data store 6000. The performance problem mentioned here means that an actual measurement value is different from a prediction value. In this embodiment, the IT management program 5210 manages the computer 3000 and the storage array 4000 that are management targets. The IT management program 5210, however, may manage a management target different from the computer 3000 and the storage array 4000. Details of the IT management program 5210 will be described later.

The management target table 5220 is a table that stores information of the computer 3000 and the storage array 4000, which are the management targets managed by the IT management program 5210. Details of the management target table 5220 will be described later.

The configuration information table 5230 is a table that stores configuration information on the computer 3000 and the storage array 4000. Details of the management target table 5220 will be described later.

The management operation table 5240 is a table that stores a log of management operations executed on the computer 3000 and the storage array 4000 by the IT management program 5210 and information of a schedule of management operations scheduled to be executed in future.

Information stored in the management operation table 5240 is not limited to the log of management operations that an IT administrator has executed using the IT management program 5210 and the schedule of management operations registered. Other logs and schedules may be stored in the management operation table 5240. For example, when the IT management program 5210 has management operation execution rules and executes a specific management operation in response to the occurrence of a change in the metrics data on the computer 3000 and the storage array 4000, according not to the IT administrator's operation but to the execution rules, a log and/or a schedule of the management operation may be registered in the management operation table 5240. Details of the management target table 5220 will be described later.

The operation influence table 5250 is a table that stores information indicating the details of an influence a management operation exerts on the computer 3000 and the storage array 4000, the management operation being executed on the computer 3000 and the storage array 4000 by the IT management program 5210. Details of the management target table 5220 will be described later.

The retraining necessity determining program 5280 is a program for determining whether retraining of the ML model 5320 is necessary when a performance problem with the ML model 5320 is detected by the IT management program 5210. Details of the retraining necessity determining program 5280 will be described later.

The storage device 5300 and the memory 5200 may also store general programs and tables for managing the computer 3000 and the storage array 4000. For example, the memory 5200 may store a table holding user authentication information (user names, passwords, access authorities, and the like).

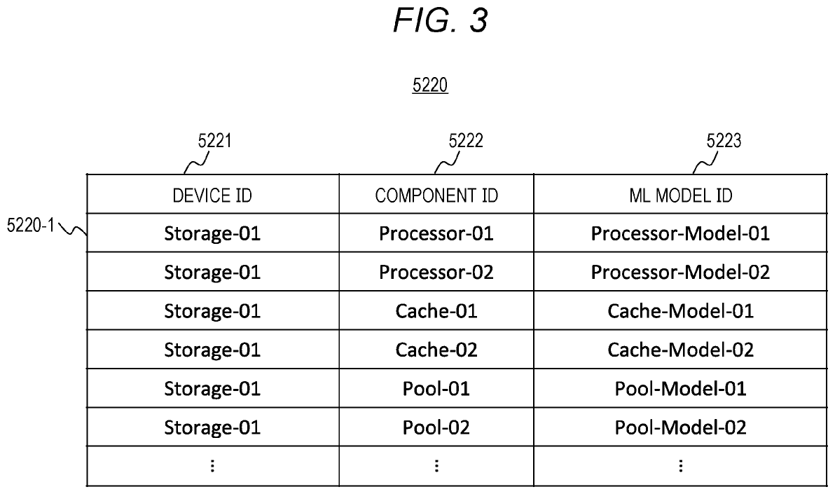

FIG. 3 depicts an example of the management target table 5220 according to this embodiment. The management target table 5220 is a table that stores information of the computer 3000 and the storage array 4000, which are the management targets managed by the IT management program 5210. The management target table 5220 includes a device ID column 5221, a component ID column 5222, and an ML model ID column 5223.

The device ID column 5221 stores device IDs that are identifiers given respectively to computers 3000 and storage arrays 4000. The component ID column 5222 stores component IDs that are identifiers given respectively to components included in the computer 3000 and the storage array 4000. The ML model ID column 5223 stores model IDs that are identifiers given respectively to ML models.

In the example shown in FIG. 3, for example, a record denoted by 5220-1 indicates that a storage array 4000 identified by a device ID “Storage-01” includes a component (processor) identified by a component ID “Processor-01”, and that to predict a future value of metrics data on the processor, an ML model identified by an ML model ID “Processor-Model-01” is used. In this embodiment, one ML model identified by an ML model ID is allocated to a pair of a device ID and a component ID. ML model allocation is, however, not limited to this. In another example, a plurality of ML models may be allocated to a pair of a device ID and a component ID. Also, the same ML model may be allocated to pairs of a device ID and a component ID.

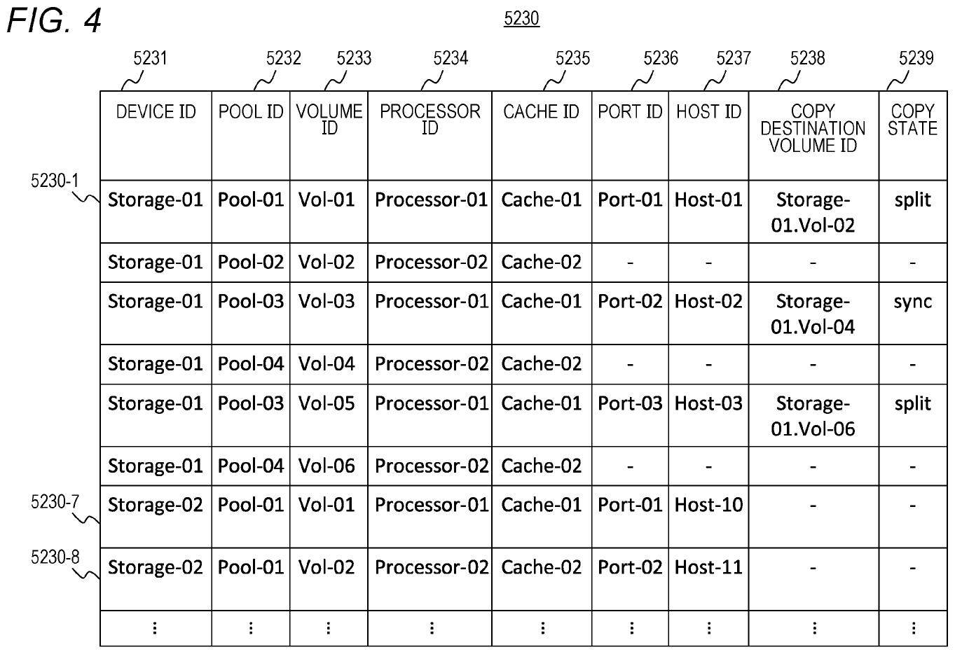

FIG. 4 depicts an example of the configuration information table 5230 according to this embodiment. The configuration information table 5230 is a table that stores information indicating configurations of the computer 3000 and the storage array 4000. The configuration information table 5230 includes a device ID column 5231, a pool ID column 5232, a volume ID column 5233, a processor ID column 5234, a cache ID column 5235, a port ID column 5236, a host ID column 5237, a copy destination volume ID column 5238, and a copy state column 5239.

The device ID column 5231 stores device IDs that are identifiers given respectively to storage arrays 4000. The pool ID column 5232 stores pool IDs that are identifiers given respectively to storage area pools included in storage arrays 4000. The volume ID column 5233 stores volume IDs that are identifiers given respectively to volumes cut out from storage area pools included in storage arrays 4000. The processor ID column 5234 stores processor IDs that are identifiers given respectively to processors included in storage arrays 4000. The cache ID column 5235 stores cache IDs that are identifiers given respectively to cache areas included in storage arrays 4000. The port ID column 5236 stores port IDs that are identifiers given respectively to network ports for data input/output, the network ports being included in storage arrays 4000. The host ID column 5237 stores host IDs that are identifiers given respectively to computers 3000 to which volumes included in storage arrays 4000 are allocated. The copy destination volume ID column 5238 stores copy destination volume IDs that are identifiers given respectively to data copy destination volumes among volumes included in storage arrays 4000.

In this embodiment, a copy destination volume ID is formatted such that a device ID and a volume ID for a data copy destination are coupled by a dot symbol. Specifically, when a device ID entry in the copy destination volume ID 5238 indicates the same storage array 4000 as indicated by a device ID entry in the device ID 5231, it indicates that data copy in the same storage array, i.e., local copy is carried out. When a device ID entry in the copy destination volume ID 5238 indicates a storage array 4000 different from a storage array 4000 indicated by a device ID entry in the device ID 5231, on the other hand, it indicates that data copy between different storage arrays, i.e., remote copy is carried out.

The copy state column 5239 stores data copy states of volumes included in storage arrays 4000.

In FIG. 4, two types of states “split” and “sync” are indicated in the copy state column 5239. The “split” state represents a state in which data copy from a volume indicated in the volume ID 5233 to a volume indicated in the copy destination volume ID 5238 is stopped. When the copy state “split” holds, therefore, even if a computer 3000 indicated in the host ID 5237 writes data to the volume indicated in the volume ID 5233, the data is not copied to the volume indicated in the copy destination volume ID 5238. Meanwhile, the “sync” state represents a state in which data copy from the volume indicated in the volume ID 5233 to the volume indicated in the copy destination volume ID 5238 is continued. When the copy state “sync” holds, therefore, if the computer 3000 indicated in the host ID 5237 writes data to the volume indicated in the volume ID 5233, the data is copied to the volume indicated in the copy destination volume ID 5238. Copy states stored in the copy state column 5239 are not limited to “split” and “sync” shown above, and other copy states may be stored in the copy state column 5239.

In response to data writing from the computer 3000 indicated in the host ID 5237, copying of the data to the volume indicated in the copy destination volume ID 5238 may be carried out synchronously or asynchronously. The data copying is carried out synchronously in the following manner: when the computer 3000 indicated in the host ID 5237 writes data to the volume indicated in the volume ID 5233, the storage array 4000 completes a process of copying the data to the volume indicated in the copy destination volume ID 5238 and then sends a response message informing of completion of data writing, to the computer 3000 indicated in the host ID 5237. In contrast, the data copying is carried out asynchronously in the following manner: when the computer 3000 indicated in the host ID 5237 writes data to the volume indicated in the volume ID 5233, the storage array 4000 sends a response message informing of completion of data writing, to the computer 3000 indicated in the host ID 5237 and then carries out the process of copying the data to the volume indicated in the copy destination volume ID 5238.

In the example shown in FIG. 4, for example, the record denoted by 5230-1 indicates that the storage array 4000 identified by the device ID “Storage-01” includes a storage area pool identified by a pool ID “Pool-01”, that a volume identified by a volume ID “Vol-01” is cut out from the pool, that a processor identified by a processor ID “Processor-01” carries out I/O processing on the volume, that a cache area identified by a cache ID “Cache-01” is allocated to the volume, that the volume is allocated to a computer 3000 identified by a host ID “Host-01”, via a port identified by a port ID “Port-01”, that data in the volume is copied to a volume identified by a copy destination volume ID “Storage-01. Vol-02”, and that a data copy state of the volume is the “split” state.

Information stored in the configuration information table 5230 is not limited to the information shown in FIG. 4. The configuration information table 5230 may store other information on the configurations of the computer 3000 and the storage array 4000. The configuration information table 5230 may further store, for example, types of data copy from volumes, such as full copy and snapshot.

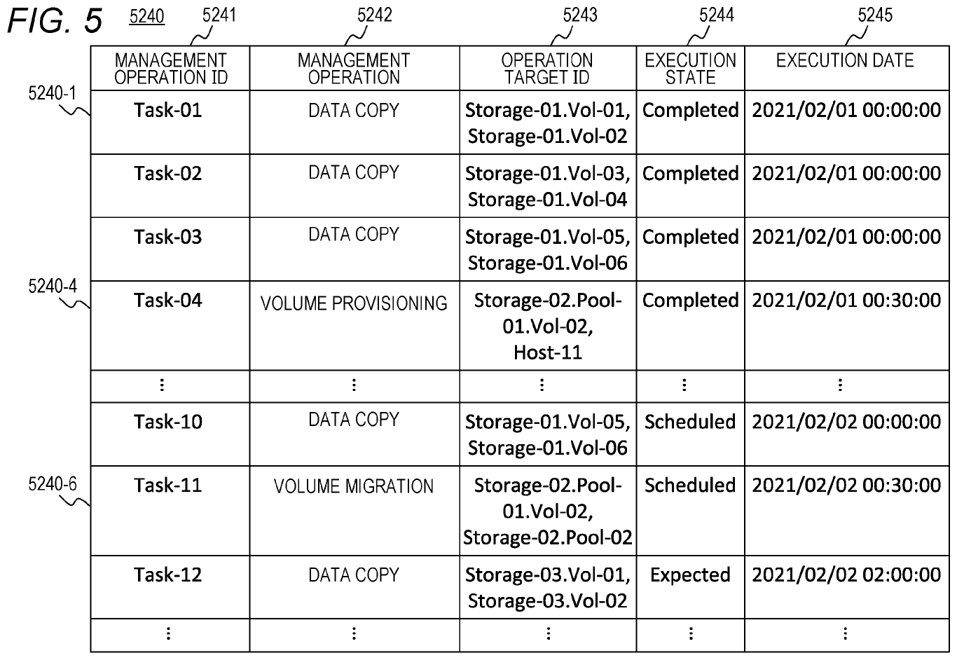

FIG. 5 depicts an example of the management operation table 5240 according to this embodiment. The management operation table 5240 is a table that stores a log of management operations executed on the computer 3000 and the storage array 4000 by the IT management program 5210 and information of a schedule of management operations scheduled to be executed in future. Hereinafter, a log of the management operations may be referred to as a management operation log. Likewise, a schedule of management operations may be referred to as a management operation schedule. The management operation table 5240 includes a management operation ID column 5241, a management operation column 5242, an operation target ID column 5243, an execution state column 5244, and an execution date column 5245.

The management operation column 5241 stores management operation IDs that are identifiers given respectively to management operation types. The management operation column 5242 stores the names of management operations. The operation target ID column 5243 stores operation target IDs that are identifiers given respectively to operation targets to be subjected to management operations. In this embodiment, an operation target ID is formatted such that a device ID and a component ID are coupled by a dot symbol, the device ID and the component ID representing a device and a component to be subjected to a management operation. The execution state column 5244 stores states of execution of management operations. The execution date column 5245 stores the dates of execution of management operations.

In this embodiment, the execution state column 5244 stores one of three states: “Completed”, “Scheduled”, and “Expected”. The “Completed” state indicates that a management operation was completed at a date indicated in the execution date column 5245. A record with “Completed” stored in the execution state column 5244 is, therefore, a management operation log. The “Scheduled” state indicates that a management operation is scheduled to be executed at a date indicated in the execution date column 5245. A record with “Scheduled” stored in the execution state column 5244 is, therefore, a management operation schedule. The “Expected” state indicates that a management operation is expected to be executed at a date indicated in the execution date column 5245. This means that although a schedule for the management operation is not explicitly registered by the IT administrator or the IT management program 5210, past cycles of execution of the management operation give an expectation that the management operation will be executed at the date. A record including the “Expected” state is generated by the IT management program 5210. The IT management program 5210 regularly monitors the management operation table 5240, groups management operations of which the execution state is defined as “Completed” according to entries in the management operation column 5242 and the operation target ID 5243, by management operation names and operation target IDs, determines whether the execution date column 5245 of the grouped management operations show a cyclic tendency, and when the dates of execution show the cyclic tendency, infers that the management operations will be executed according to the cyclic tendency, thus creating a record including the “Expected” state. In this embodiment, a record including the execution state “Expected” is treated as a type of a management operation schedule in the same manner as a record including the execution state “Scheduled” is.

In the example shown in FIG. 5, for example, in a record denoted by 5240-1, a management operation identified by a management operation ID “Task-01” is a management operation of copying data from the volume identified by “Storage-01. Vol-01” to the volume indicated by “Storage-01. Vol-02”, as indicated by entries in the management operation column 5242 and the operation target ID 5243. As indicated by entries in the execution state column 5244 and the execution date column 5245, execution of the management operation was completed at a date “2021/02/01 00:00:00”.

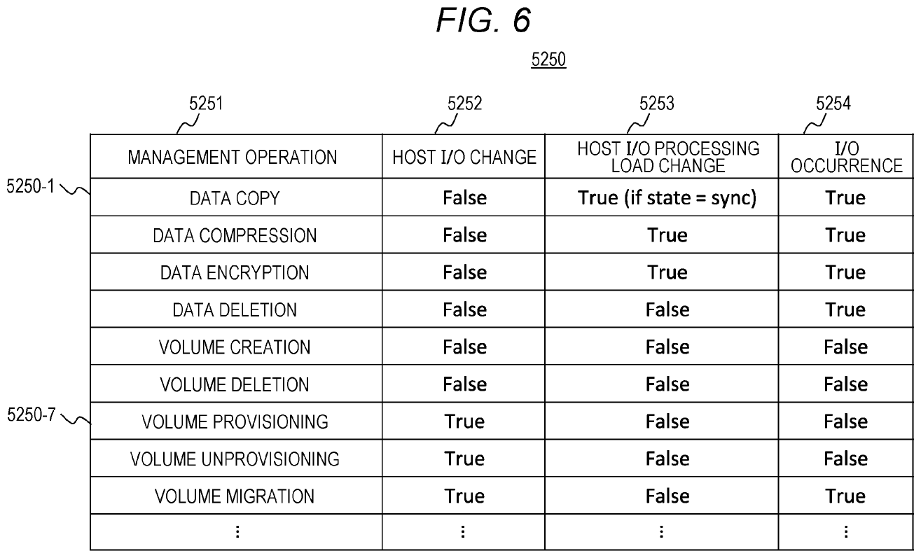

FIG. 6 depicts an example of the operation influence table 5250 according to this embodiment. The operation influence table 5250 is a table that stores information on an influence a management operation exerts on the computer 3000 and the storage array 4000, the management operation being executed on the computer 3000 and the storage array 4000 by the IT management program 5210. The operation influence table 5250 includes a management operation column 5251, a host I/O change column 5252, a host I/O processing load change column 5253, and an I/O occurrence column 5254.

The management operation column 5251 stores the names of management operations. The host I/O change column 5252 stores information indicating whether a management operation changes host I/O. Host I/O mentioned here is input/output from/to the computer 3000 to/from a volume. Host I/O change mentioned here is a quantitative change in host I/O, that is, an increase or decrease in host I/O. The host I/O processing load change column 5253 stores information indicating whether a management operation changes, i.e., increases or decreases processing load for processing host I/O. Hereinafter, processing load for processing host I/O may be referred to as host I/O processing load. The I/O occurrence column 5254 stores information indicating whether a management operation gives rise to I/O.

In the example shown in FIG. 6, for example, a record denoted by 5250-1 indicates that a management operation “data copy” does not change host I/O and changes host I/O processing load when the copy state is “sync” but does not change the same when the copy state is not “sync”, and that the management operation itself gives rise to I/O. A record denoted by 5250-7, for example, indicates that a management operation “volume provisioning” changes host I/O but does not change host I/O processing load, and that the management operation itself does not give rise to I/O.

In this embodiment, pieces of information stored in the operation influence table 5250 are each defined in advance. However, these piece of information may be defined in a different manner. The information may be defined, for example, in such a manner that after executing a management operation on the computer 3000 and the storage array 4000, the IT management program 5210 monitors a change in I/O to/from the computer 3000 and the storage array 4000 and, based on an observed change, adds information to the operation influence table 5250 or update information in the operation influence table 5250.

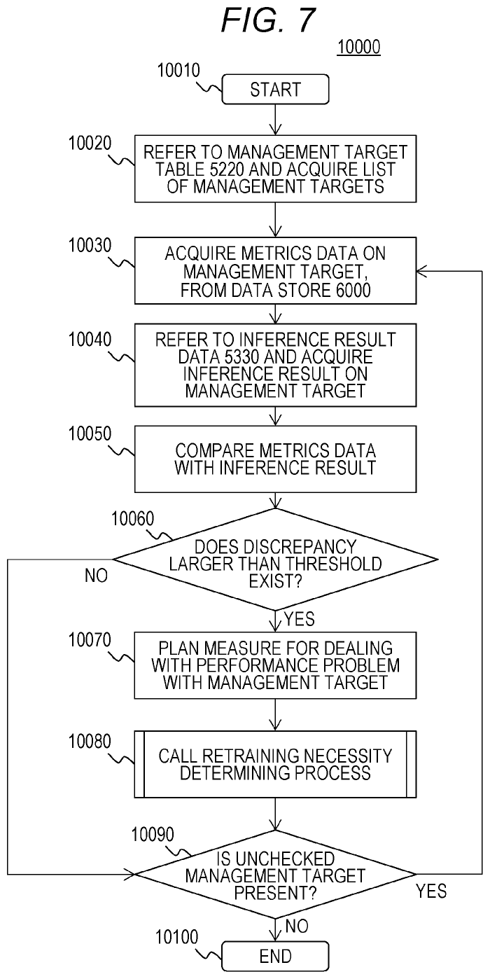

FIG. 7 is a flowchart of an example of a procedure of a monitoring process executed by the IT management program 5210. The IT management program 5210 monitors the computer 3000 and the storage array 4000 according to the procedure shown in FIG. 7. According to the procedure shown in FIG. 7, the IT management program 5210 compares the inference result data 5330 generated by the inference program 5270 with metrics data on the computer 3000 and the storage array 4000, the metrics data being stored in the data store 6000, thereby identifying a performance problem.

The monitoring process is started at step 10010. This process is started periodically by the IT management program 5210, but may be started in a different manner.

At step 10020, the IT management program 5210 refers to the management target table 5220 and acquires a list of management targets.

At step 10030, the IT management program 5210 acquires metrics data on a management target, from the data store 6000.

At step 10040, the IT management program 5210 refers to the inference result data 5330, and acquires an inference result on the management target. In this embodiment, the inference result on the management target refers to a future prediction value of the metrics data on the management target.

At step 10050, the IT management program 5210 compares the metrics data on the management target, the metrics data being acquired at step 10030, with the inference result acquired at step 10040. A relationship between the inference result acquired at step 10040 and the metrics data acquired at step 10030 is a relationship between a prediction value of the metrics data on the management target and a correct answer (actual measurement value) to the prediction value.

At step 10060, the IT management program 5210 determines whether a discrepancy lager than a given threshold exits between the metrics data on the management target, the metrics data being acquired at step 10030, and the inference result acquired at step 10040. When it is determined that the discrepancy lager than the given threshold exits, the process flow proceeds to step 10070. When it is not determined that the discrepancy lager than the given threshold exits, the process flow proceeds to step 10090. That the discrepancy lager than the given threshold exits means that an actual measurement value widely different from the prediction value of the metrics data has been observed, indicating a possibility that a performance problem has occurred. It is also understood from the viewpoint of the accuracy of an ML model that observation of an actual measurement value widely different from the prediction value indicates a deterioration in the accuracy of the ML model. The discrepancy lager than the given threshold, therefore, indicates a possibility that a concept drift has occurred.

According to this embodiment, in the above manner, a concept drift is detected based on the accuracy of the ML model. A method of detecting a concept drift is, however, not limited to this, and a concept drift may be detected by a different method. For example, a method may be adopted according to which a statistical feature quantity of metrics data used for training the ML model is compared with a statistical feature quantity of recent metrics data acquired at step 10030, and when a discrepancy larger than the threshold exists between these statistical feature quantities, it is determined that a concept drift has occurred.

At step 10070, the IT management program 5210 plans a management operation as a measure for dealing with the performance problem with management target. In this embodiment, the IT management program 5210 has management operation execution rules, and registers a schedule for execution of a specific management operation for dealing with a performance problem with the computer 3000 and the storage array 4000, with the management operation table 5240.

The process at step 10030 and the process at step 10070 will be described, using one example. A record denoted by 5230-7 in FIG. 4 indicates that a storage array 4000 identified by “Storage-02” has a storage area pool identified by “Pool-01”, that a volume identified by “Vol-01” is cut out from the pool, and that the volume is allocated to a computer 3000 identified by “Host-10”. Now it is assumed that, as indicated in a record 5240-4 of FIG. 5, a management operation of allocating a volume identified by “Storage-02. Pool-01. Vol-02” to a computer 3000 identified by “Host-11” has been carried out. As a result, as indicated in a record denoted by 5230-8 in FIG. 4, the volume identified by “Vol-02” is cut out from the storage area pool identified by “Pool-01”, the storage area pool being included in the storage array 4000 identified by “Storage-02”, and is allocated to the computer 3000 identified by “Host-11”. Before execution of the management operation, only the data from/to the computer 3000 identified by “Host-10” flows into/out of the storage area pool identified by “Pool-01”, the storage area pool being included in the storage array 4000 identified by “Storage-02”. As a result of execution of the management operation, then, data from/to the computer 3000 identified by “Host-11” newly flows into/out of the pool.

It is now assumed that the IT management program 5210 has executed the management process (monitoring process) shown in FIG. 7. It is also assumed that the management target is the storage area pool identified by “Pool-01”, the storage area pool being included in the storage array 4000 identified by “Storage-02”. As described above, at step 10060, the IT management program 5210 determines whether the discrepancy larger than the threshold exists between the metrics data on the management subject acquired at step 10030, i.e., the storage area pool identified by “Pool-01”, the storage area pool being included in the storage array 4000 identified by “Storage-02”, and the inference result acquired at step 10040. The inference result acquired at step 10040 is an inference result given by predicting a future value of the metrics data on the pool, using a ML model learned from data in the past in which only the data from/to the computer 3000 identified by “Host-10” flown into/out of the pool. The metrics data acquired at step 10030, on the other hand, is metrics data reflecting the current state in which data from/to the computer 3000 identified by “Host-10” and from/to the computer 3000 identified by “Host-11” flows into/out of the pool. When finding that a sufficient amount of data flows from/to the computer 3000 identified by “Host-11” into/out of the pool, the IT management program 5210 determines that a discrepancy larger than the threshold exists between the inference result and the metrics data, that is, the pool has a performance problem.

In response to this determination result, the IT management program 5210, at step 10070, plans a management operation as a measure for dealing with the performance problem with the pool, and registers a schedule for execution of the management operation with the management operation table 5240.

A record denoted by 5240-6 in FIG. 5 indicates a management operation that the IT management program 5210 registers with the management operation table 5240 to solve the performance problem with the pool. This management operation is an operation of transferring the volume identified by “Storage-02. Pool-01. Vol-02” to a pool identified by “Storage-02. Pool-02”. By executing this management operation, a storage area source for the volume identified by “Storage-02. Pool-01. Vol-02” is changed from the pool identified by “Storage-02. Pool-01” to the pool identified by “Storage-02. Pool-02”. As a result, only the data from/to the computer 3000 identified by “Host-10” flows into/out of the pool identified by “Storage-02. Pool-01”, and data from/to the computer 3000 identified by “Host-11” flows into/out of the pool identified by “Storage-02. Pool-02”. Hence the performance problem with the pool identified by “Storage-02. Pool-01” is solved. What is described above is the description of step 10030 and step 10070, using a specific example.

FIG. 7 is referred to again. At step 10080, the IT management program 5210 calls a retraining necessity determining process of the retraining necessity determining program 5280. Details of the retraining necessity determining process will be described later.

At step 10090, the IT management program 5210 determines whether an unchecked management target is present in the list of management targets acquired at step 10020. When it is determined that an unchecked management target is present, the process flow returns to step 10030. When it is not determined that an unchecked management target is present, the process flow proceeds to step 10100 to end the whole process.

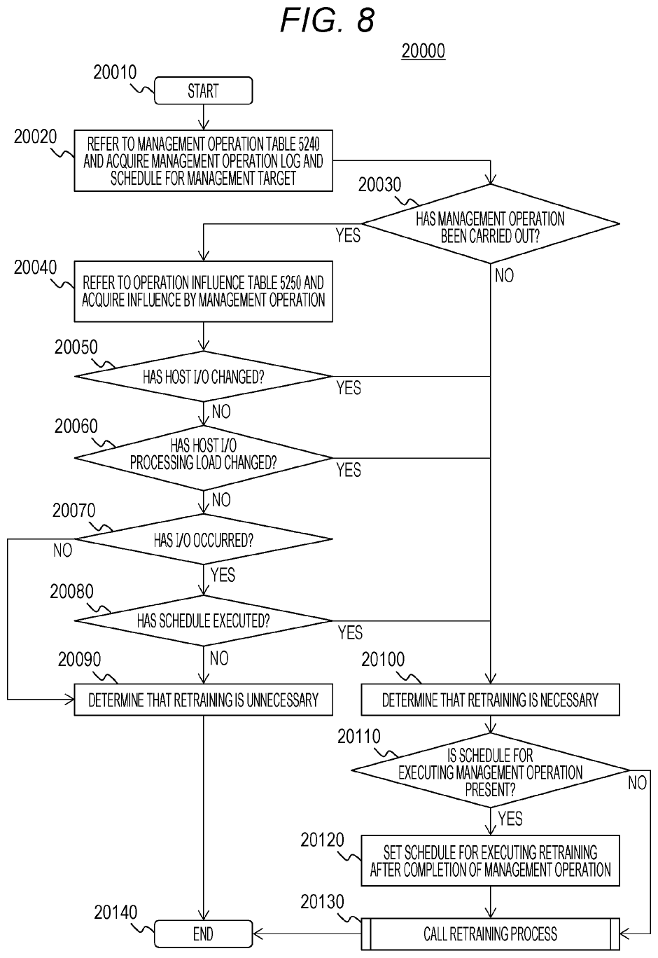

FIG. 8 is a flowchart of a procedure of a retraining necessity determining process executed by the retraining necessity determining program 5280. Following the procedure shown in FIG. 8, the retraining necessity determining program 5280 determines whether retraining an ML model for monitoring a specific management target is necessary.

The retraining necessity determining process is started at step 20010. This process is started when the IT management program 5210 calls the process at step 10080 during execution of the monitoring process shown in FIG. 7. The process, however, may be started in a different manner. In this embodiment, the IT management program 5210 delivers the identifier for the management target on which existence of the discrepancy larger than the threshold is determined at step 10060, such as the identifier “Storage-02. Pool-01”, to the retraining necessity determining program 5280 to call the process.

At step 20020, the retraining necessity determining program 5280 refers to the management operation table 5240, and acquires a management operation log and a management operation schedule on the management target corresponding to the identifier that is delivered to the retraining necessity determining program 5280 at the time of calling the process. Specifically, the retraining necessity determining program 5280 extracts a record having the identifier for the management target entered in the operation target ID column 5243, from the management operation table 5240. Among extracted records, a record with “Completed” stored in the execution state column 5244 represents a management operation log. A record with “Scheduled” or “Expected” stored in the execution state column 5244 is a management operation schedule.

At step 20030, the retraining necessity determining program 5280 determines whether a management operation has been carried out on the management target. Specifically, when extracting at least one management operation log at step 20020, the retraining necessity determining program 5280 determines that the management operation has been carried out. When it is determined that the management operation has been carried out, the process flow proceeds to step 20040. When it is not determined that the management operation has been carried out, the process flow proceeds to step 20100.

At step 20040, the retraining necessity determining program 5280 refers to the operation influence table 5250, and acquires information on an influence by the management operation. Specifically, the retraining necessity determining program 5280 determines whether an entry in the management operation column 5242 of the management operation log (record) extracted at step 20020 matches an entry in the management operation column 5251 of the operation influence table 5250, and acquires information on the influence by the management operation, from a record in the operation influence table 5250, the record having the entry in the management operation column 5251 that matches the entry in the management operation column 5242.

At step 20050, the retraining necessity determining program 5280 refers to the information on the influence by the management operation, the information being acquired at step 20040, and determines whether an entry in the host I/O change column 5252 is “True”. When it is determined that the entry in the host I/O change column 5252 is “True”, the process flow proceeds to step 20100. When it is not determined that the entry in the host I/O change column 5252 is “True”, the process flow proceeds to step 20060.

At step 20060, the retraining necessity determining program 5280 refers to the information on the influence by the management operation, the information being acquired at step 20040, and determines whether an entry in the host I/O processing load change column 5253 is “True”. When it is determined that the entry in the host I/O processing load change column 5253 is “True”, the process flow proceeds to step 20100. When it is not determined that the entry in the host I/O processing load change column 5253 is “True”, the process flow proceeds to step 20070.

At step 20070, the retraining necessity determining program 5280 refers to the information on the influence by the management operation, the information being acquired at step 20040, and determines whether an entry in the I/O occurrence column 5254 is “True”. When it is determined that the entry in the I/O occurrence column 5254 is “True”, the process flow proceeds to step 20080. When it is not determined that the entry in the I/O occurrence column 5254 is “True”, the process flow proceeds to step 20090.

At step 20080, the retraining necessity determining program 5280 determines whether the management operation is to be executed according to the schedule. Specifically, when at least one schedule having a management operation identical with the management operation and a management target identical with the management target for the management operation is present among management operation schedules extracted at step 20020, the retraining necessity determining program 5280 determines that the management operation is to be executed according to the schedule. When it is determined that the management operation is to be executed according to the schedule, the process flow proceeds to step 20100. When it is not determined that the management operation is to be executed according to the schedule, the process flow proceeds to step 20090.

At step 20090, the retraining necessity determining program 5280 determines that retraining the ML model for monitoring the management target is unnecessary. Following execution of this step, the process flow proceeds to step 20140 to end the whole process.

At step 20100, the retraining necessity determining program 5280 determines that retraining the ML model for monitoring the management target is necessary.

At step 20110, the retraining necessity determining program 5280 determines whether a schedule for executing a management operation on the management target is present. Specifically, when at least one schedule extracted at step 20020 is present, the retraining necessity determining program 5280 determines that the schedule for executing the management operation is present. When it is determined that the schedule for executing the management operation is present, the process flow proceeds to step 20120. When it is not determined that the schedule for executing the management operation is present, the process flow proceeds to step 20130.

At step 20120, after completion of the management operation scheduled to be executed on the management target, the retraining necessity determining program 5280 sets a schedule for execution of retraining of the ML model for monitoring the management target.

At step 20130, the retraining necessity determining program 5280 calls a retraining process of the training program 5260. Details of the retraining necessity determining process will be described later. Following execution of this step, the process flow proceeds to step 20140 to end the whole process.

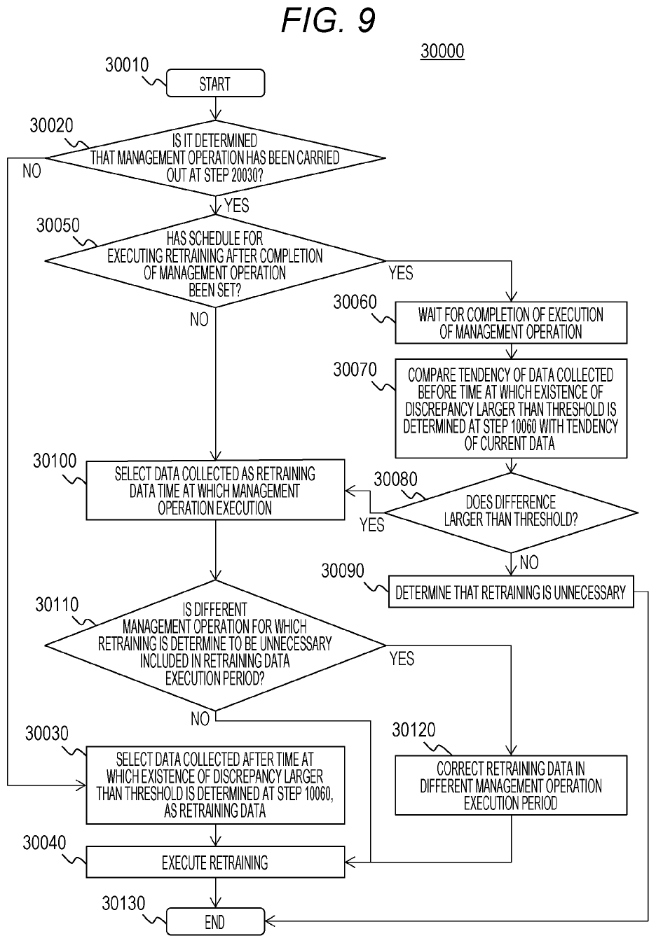

FIG. 9 is a flowchart of an example of a procedure of the retraining process executed by the training program 5260. The training program 5260 relearns the ML model according to the procedure shown in FIG. 9.

The retraining process is started at step 30010. This process is started when the retraining necessity determining program 5280 calls the process at step 20130 during execution of the retraining necessity determining process shown in FIG. 8. This process, however, may be started in a different manner.

According to this embodiment, when the process is called, the following pieces of information are delivered to the training program 5260: the identifier for the ML model of which retraining is determined to be necessary at step 20100 by the retraining necessity determining program 5280, the result of determination made at step 20030 on whether the management operation has been carried out, information about whether the schedule for executing retraining after completion of the management operation is set at step 20120, and a time at which the IT management program 5210 determines at step 10060 of the monitoring process flow of FIG. 7 that the discrepancy larger than the threshold exists.

At step 30020, the training program 5260 determines whether the retraining necessity determining program 5280 has determined that the management operation has been carried out at step 20030. When the retraining necessity determining program 5280 has determined that the management operation has been carried out, the process flow proceeds to step 30050. When the retraining necessity determining program 5280 has not determined that the management operation has been carried out, the process flow proceeds to step 30030.

At step 30030, the training program 5260 selects metrics data as retraining data, the metrics data being collected after the time at which the IT management program 5210 determines at step 10060 of the monitoring process flow of FIG. 7 that the discrepancy larger than the threshold exists.

At step 30040, the training program 5260 executes retraining of the ML model, using the retraining data selected at step 30030. Following execution of this step, the process flow proceeds to step 30130 to end the whole process.

At step 30050, the training program 5260 determines whether the retraining necessity determining program 5280 has set a schedule, at step 20120 of the retraining necessity determining process shown in FIG. 8, for executing retraining after completion of the management operation. When it is determined that the retraining necessity determining program 5280 has set the schedule for executing retraining after completion of the management operation, the process flow proceeds to step 30060. When it is not determined that the retraining necessity determining program 5280 has set the schedule for executing retraining after completion of the management operation, the process flow proceeds to step 30100.

At step 30060, the training program 5260 waits for completion of execution of the scheduled management operation.

At step 30070, the training program 5260 compares a tendency of metrics data collected before the time at which the IT management program 5210 determines at step 10060 of the monitoring process flow of FIG. 7 that the discrepancy larger than the threshold exists with a tendency of current metrics data. A method of comparing the tendencies of both metrics data is not limited to a specific method. For example, statistical feature quantities of both data may be compared.

At step 30080, the training program 5260 determines whether a difference larger than a threshold exists between the tendencies of both data. When it is determined that the difference larger than the threshold exists between the tendencies of both data, the process flow proceeds to step 30100. When it is not determined that the difference larger than the threshold exists between the tendencies of both data, the process flow proceeds to step 30090.

At step 30090, the training program 5260 determines that retraining the ML model is unnecessary. This is a process for dealing with a case where retraining is unnecessary because a concept drift occurring at the ML model has been eliminated as a result of execution of a management operation on a management target the ML model monitors. This is a case where the tendency of the current metrics data moves back closer to the tendency of the metrics data collected before the time at which the IT management program 5210 determines at step 10060 of the monitoring process flow of FIG. 7 that the discrepancy larger than the threshold exists. Following execution of this step, the process flow proceeds to step 30130 to end the whole process.

At step 30100, the training program 5260 selects metrics data as retraining data, the metric data being collected after a time at which the management operation execution of which is waited for at step 30060 is executed.

At step 30110, the training program 5260 determines whether a different management operation for which retraining is determined to be unnecessary is included in a retraining data execution period. When it is determined that a different management operation for which retraining is determined to be unnecessary is included in the retraining data execution period, the process proceeds to step 30120. When it is not determined that a different management operation for which retraining is determined to be unnecessary is included in the retraining data execution period, the process proceeds to step 30040.

At step 30120, the training program 5260 corrects retraining data in an execution period of the different management operation.

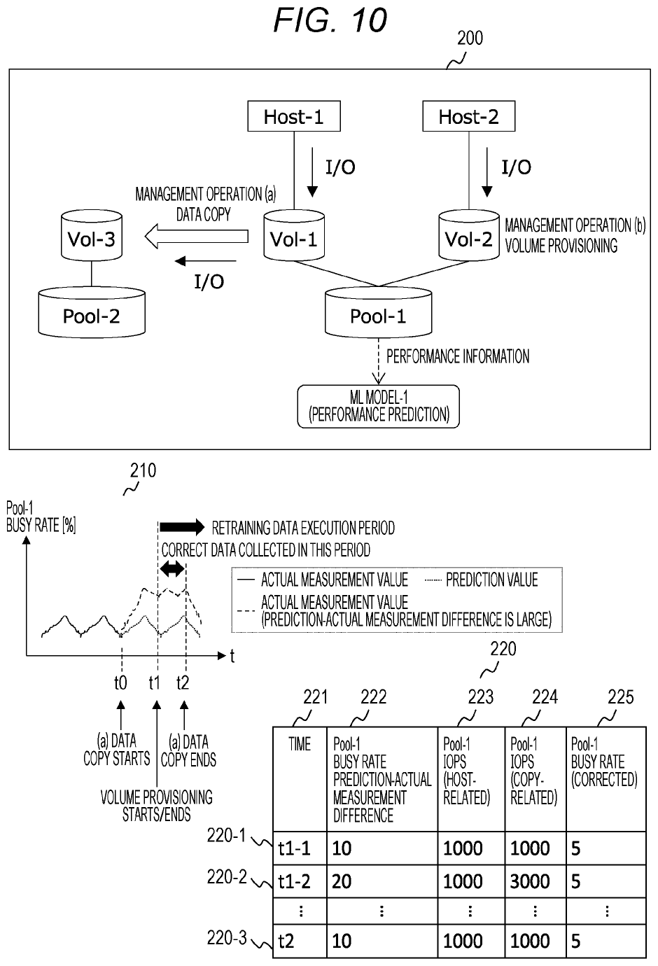

The process at step 30110 and the process at step 30120 will be described, using one example. FIG. 10 is a conceptual diagram showing the state of correction of retraining data. In a computing environment 200 of FIG. 10, a volume identified by “Vol-1” is cut out from a storage capacity pool identified by “Pool-1” and is allocated to a computer 3000 indicated by “Host-1”. An ML model identified by the “ML model-1” is an ML model that predicts a future value of the performance of the pool.

A graph 210 shows an example of the performance (busy rate) of the pool. The graph 210 shows an actual measurement value of the performance of the pool and a future value predicted by the ML model as well. In the graph, a continuous line represents an actual measurement value that is obtained when a prediction-actual measurement difference is small, and a broken line represents an actual measurement value that is obtained when the prediction-actual measurement difference is large. A dotted line represents a prediction value that is obtained when the prediction-actual measurement difference is large.

Now a case is assumed where data copy from the volume identified by “Vol-1” to a different volume is started at time denoted by “t0”. The graph 210 indicates a state in which as a result of this copy operation, the actual measurement value widely different from the prediction value is observed as the performance of the pool, that is, a concept drift has occurred. In this example, the data copy is executed as a single operation, and it is determined in that case that the ML model identified by “ML model-1” should not be relearned.

It is then assumed that at time denoted by “t1”, a volume identified by “Vol-2” is cut out from the storage capacity pool identified by “Pool-1” and is allocated to a computer 3000 identified by “Host-2”. As a result, data from/to the computer 3000 identified by “Host-2” is continuously input/output to/from the storage capacity pool identified by “Pool-1”. This is one factor for creating a discrepancy between the prediction value and the actual measurement value of the performance of the pool. In this assumed case, the volume provisioning is an operation that changes host I/O. For that reason, it is determined in this case that the ML model identified by “ML model-1” should be relearned.

At time denoted by “t2”, the data copy started at time denoted by “t0” is finished.

As described above, the training program 5260 determines at step 30110 of the retraining process of FIG. 9 that whether a different management operation for which retraining is determined to be unnecessary is included in the retraining data period. In this example, the retraining data period is a period starting from time denoted by “t1”. In this example, however, in a period between time denoted by “t1” and time denoted by “t2”, a different management operation for which retraining has been determined to be unnecessary, i.e., data copy is carried out. At step 30110 of the retraining process, therefore, the training program 5260 determines that a different management operation for which retraining is determined to be unnecessary is included in the retraining data period.

Subsequently, at step 30120, the training program 5260 corrects retraining data in an execution period of the different management operation. In this example, retraining data in the period between time denoted by “t1” to time denoted by “t2” is to be corrected.

A table 220 of FIG. 10 shows an example of a method of correcting retraining data. In the table 220, a time column 221 indicates points of time marked at unit time intervals in the period between time denoted by “t1” and time denoted by “t2”. A Pool-1 Busy Rate prediction-actual measurement difference column 222 indicates a difference at each point of time between a prediction value and an actual measurement value of the busy rate, which is the performance of the storage capacity pool identified by “Pool-1”.

Pool-1 IOPS (HOST-related) column 223 indicates IOPS (Input Output Per Second) issued from the computer 3000 identified by “Host-1” or “Host-2”, out of IOPS issued to the storage capacity pool identified by “Pool-1”. In this column, an average or a maximum of IOPS issued in a unit time may be used. Pool-1 IOPS (copy-related) column 224 indicates IOPS issued by a data copy operation, out of IOPS issued to the storage capacity pool identified by “Pool-1”.

The Pool-1 Busy Rate (corrected) column 225 indicates busy rates given by correcting entries in the Pool-1 Busy Rate prediction-actual measurement difference column 222. In this example, data correction is made by multiplying a value in the Pool-1 Busy Rate prediction-actual measurement difference column 222 by the ratio of a value in the Pool-1 IOPS (host-related) column 223 to the sum of a value in the pool-1 IOPS (host-related) column 223 and a value in the pool-1 IOPS (copy-related) column 224. For example, in a record denoted by 220-1, a value in the Pool-1 Busy Rate prediction-actual measurement difference column at a point of time “t1-1” is 10. Multiplying this value by the ratio of a value in the Pool-1 IOPS (host-related) column, the value being 1000, to the sum of a value in the pool-1 IOPS (host-related) column and a value in the pool-1 IOPS (copy-elated) column, the sum being 2000, that is, by 1000/(1000+1000) yields a value in the pool-1 Busy Rate (corrected), which is 5. The data correction method is not limited this, and a different correction method may be adopted. For example, a busy rate of a storage capacity pool may be estimated from metrics data on I/O issued from a host, using a performance simulator of the storage array 4000, and the resulting estimate may be used as correction data. The metrics data on I/O issued from the host includes read IOPS, write IOPS, read transfer rate, write transfer rate, and the like.

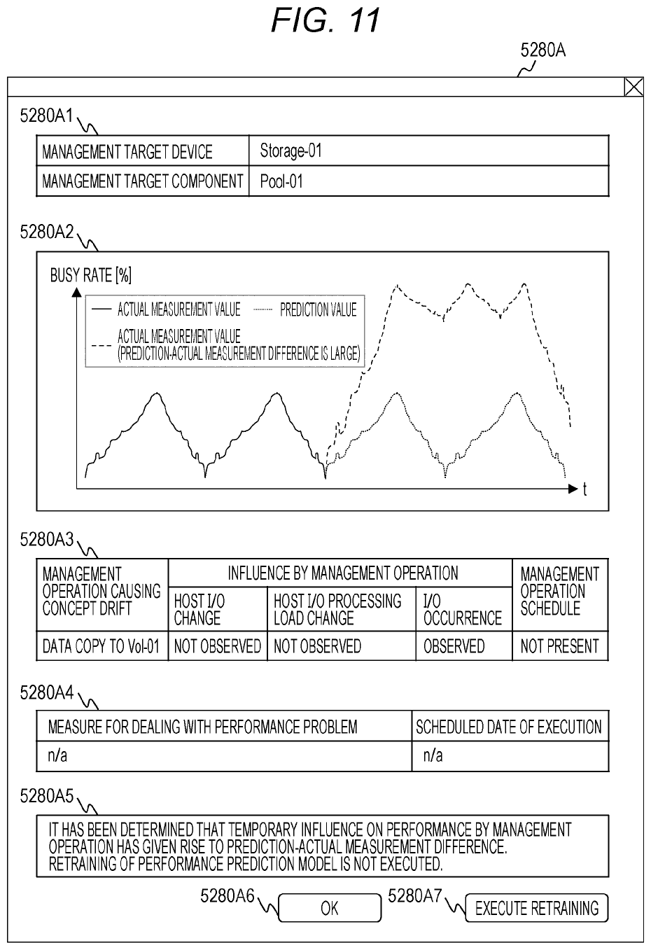

FIG. 11 depicts an example of a screen for displaying a result of retraining necessity determination. FIG. 11 depicts an example of a screen showing a result of retraining necessity determination, the result being displayed after the retraining necessity determining program 5280 executes the retraining necessity determining process shown in FIG. 8.

The example of a screen for displaying a result of retraining necessity determination 5280A includes a management target display space 5280A1, a performance graph display space 5280A2, a management operation influence display space 5280A3, a performance problem dealing measure space 5280A4, a retraining necessity determination result display space 5280A5, an OK button 5280A6, and a retraining execution button 5280A7.

The management target display space 5280A1 displays identifiers for a target device and a component managed by the IT management program 5210.

The performance graph display space 5280A2 displays a performance value of the management target as a graph. This graph displays an actual measurement value of performance of the management target and a prediction value calculated by an ML model assigned to the management target. Data displayed in this graph is metrics data and an inference result that the IT management program 5210 acquires at step 10030 and at step 10040, respectively, when carrying out the monitoring process shown in FIG. 7.

The management operation influence display space 5280A3 displays a management operation that causes a concept drift for the management target, an influence by the management operation, and the presence or absence of a schedule for the management operation. Information displayed in this space is information on an influence by a management operation and a management operation log/management operation schedule that the retraining necessity determining program 5280 acquires at step 20040 and at step 20020, respectively, when carrying out the retraining necessity determining process shown in FIG. 8.

The performance problem dealing measure space 5280A4 displays a management operation scheduled to be executed as a measure for dealing with a performance problem with the management target and a scheduled date of execution of the measure. Information displayed in this space is information on a measure the IT management program 5210 plans at step 10070 when carrying out the monitoring process shown in FIG. 7.

The retraining necessity determination result display space 5280A5 displays a description of a result of retraining necessity determination. Information displayed in this space is an explanatory note prepared in advance, the explanatory note being selected according to a branch from step 20030, step 20050, step 20060, step 20070, or step 20080 that the retraining necessity determining program 5280 has passed when carrying out the retraining necessity determining process shown in FIG. 8.

The OK button 5280A6 is a button for closing the screen for displaying the retraining necessity determination result.

The retraining execution button 5280A7 is a button for executing retraining of the ML model. When the user presses the button, the training program 5260 executes the retraining process shown in FIG. 9. In this case, only step 30030 and step 30040 of the retraining process may be executed. This allows the user to execute retraining, regardless of a determination result given by the retraining necessity determining program 5280.

The example of FIG. 11 shows a result of determination on whether retraining an ML model allocated to the storage capacity pool identified by “Pool-01” included in the storage array 4000 identified by “Storage-01”, as indicated in the management target display space 5280A1, is necessary. The performance graph display space 5280A2 displays a state in which an actual measurement value having a difference from a prediction value of a busy rate representing the performance of the pool, the difference being larger than a threshold, is observed. The management operation influence display space 5280A3 displays a data copy operation on the volume identified by “Vol-01”, as a management operation that has caused a performance problem indicated by the above prediction-actual measurement difference. It is indicated in this space that the data copy operation (management operation) has brought an influence “I/O occurrence”. It is also indicated that the data copy operation is not executed according to a schedule. In this case, according to the retraining necessity determining process shown in FIG. 8, a determination result at step 20030 is “YES”, the same at step 20050 is “NO”, the same at step 20060 is “NO”, the same at step 20070 is “YES”, and the same at step 20080 is “NO”, which gives a determination that retraining is unnecessary. The performance problem dealing measure space 5280A4 indicates that no management operation is scheduled as a measure for dealing with the prediction-actual measurement difference. The retraining necessity determination result display space 5280A5 displays a determination result stating that because the retraining necessity determining program 5280 determines that the prediction-actual measurement difference has occurred due to a temporary influence on the performance by the management operation, retraining of the ML model is not executed.

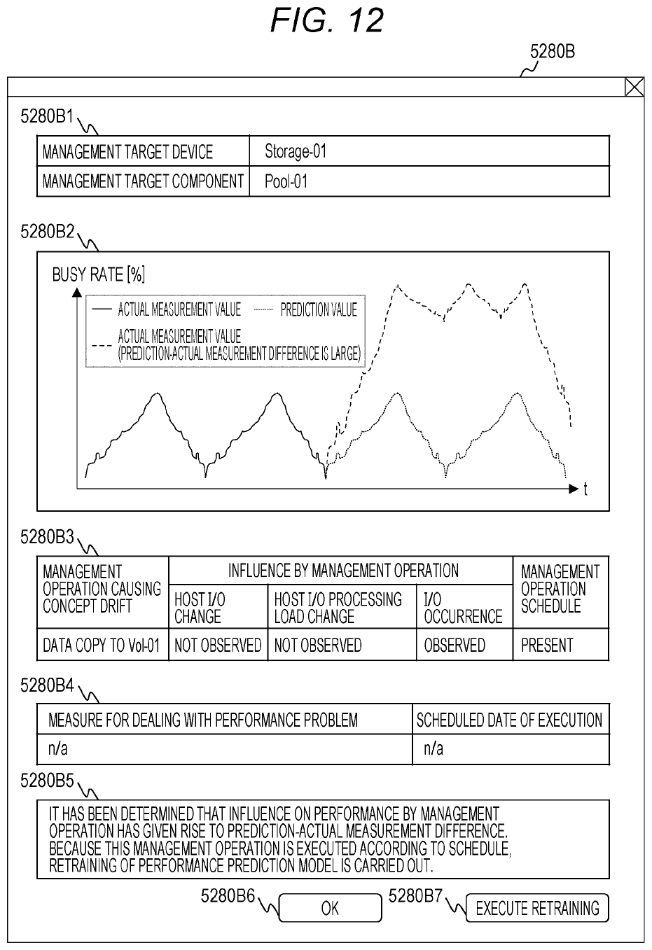

FIGS. 12, 13, and 14 depicts other examples of the screen for displaying the result of retraining necessity determination. The display screens in FIGS. 12, 13, and 14 are similar in configuration to the display screen 5280A shown in FIG. 11. Differences between FIGS. 12, 13, and 14 and FIG. 11 will mainly be described.

In FIG. 12, a management operation influence display space 5280B3 indicates that the data copy operation will be executed according to a schedule. In this case, in the retraining necessity determining process shown in FIG. 8, a determination result at step 20030 is “YES”, the same at step 20050 is “NO”, the same at step 20060 is “NO”, the same at step 20070 is “YES”, and the same at step 20080 is “YES”, which gives a determination that retraining is necessary. Thus, a retraining necessity determination result display space 5280B5 displays a determination result stating that because a performance problem indicated by a prediction-actual measurement difference has occurred due to an influence on the performance by a management operation, such as data copying, and the management operation will be executed according to the schedule, the retraining necessity determining program 5280 determines that retraining of the ML model is executed.

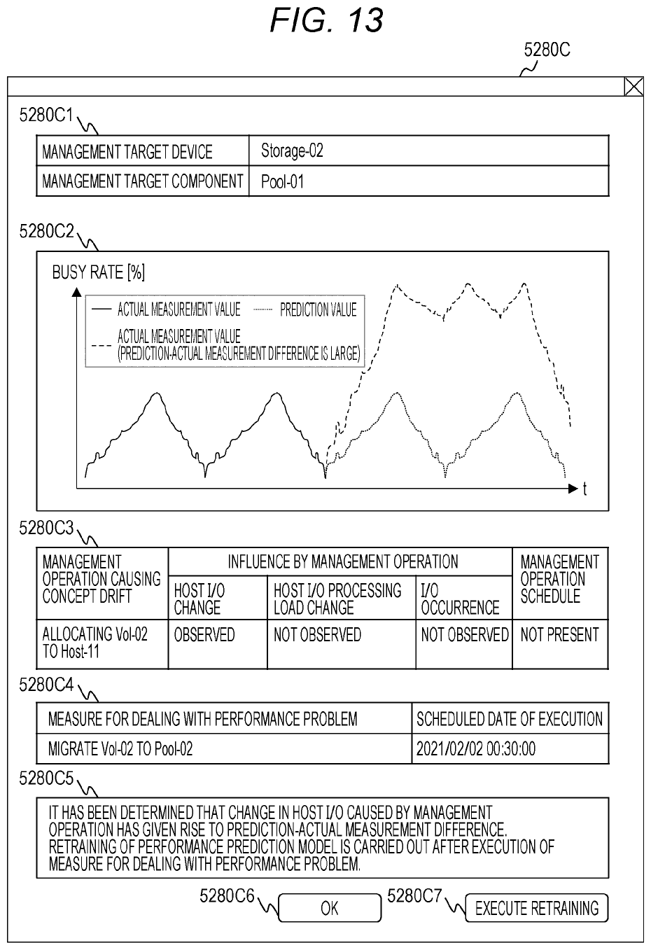

FIG. 13 shows a result of determination on whether retraining an ML model assigned to the storage capacity pool identified by “Pool-01” included in the storage array 4000 identified by “Storage-02”, as indicated in a management target display space 5280C1, is necessary. A management operation influence display space 5280C3 displays a fact that a performance problem indicated by a prediction-actual measurement difference observed at the pool is caused by allocation of the volume identified by “Vol-02” to a computer 3000 identified by “Host-11” and that this allocation has brought an influence “host I/O change”. In this case, in the retraining necessity determining process shown in FIG. 8, a determination result at step 20030 is “YES”, and the same at step 20050 is “YES”, which gives a determination that retraining is necessary. A performance problem dealing measure space 5280C4 displays that as a measure for dealing with the prediction-actual measurement difference, a management operation of transferring a storage capacity source for the volume identified by “Vol-02” to the storage capacity pool identified by “Pool-02” is scheduled to be executed at time “2021/02/02 00:30:00”. In this case, in the retraining necessity determining process of FIG. 8, a determination result at step 20110 is “YES”, so that a schedule is set for execution of retraining after completion of the management operation. Hence a retraining necessity determination result display space 528005 displays a determination result stating that because the performance problem indicated by the prediction-actual measurement difference has occurred due to an influence on the performance by volume provisioning. i.e., management operation and volume migration is scheduled as a measure for dealing with the performance problem, the retraining necessity determining program 5280 determines that retraining of the ML model is executed after execution of the measure.

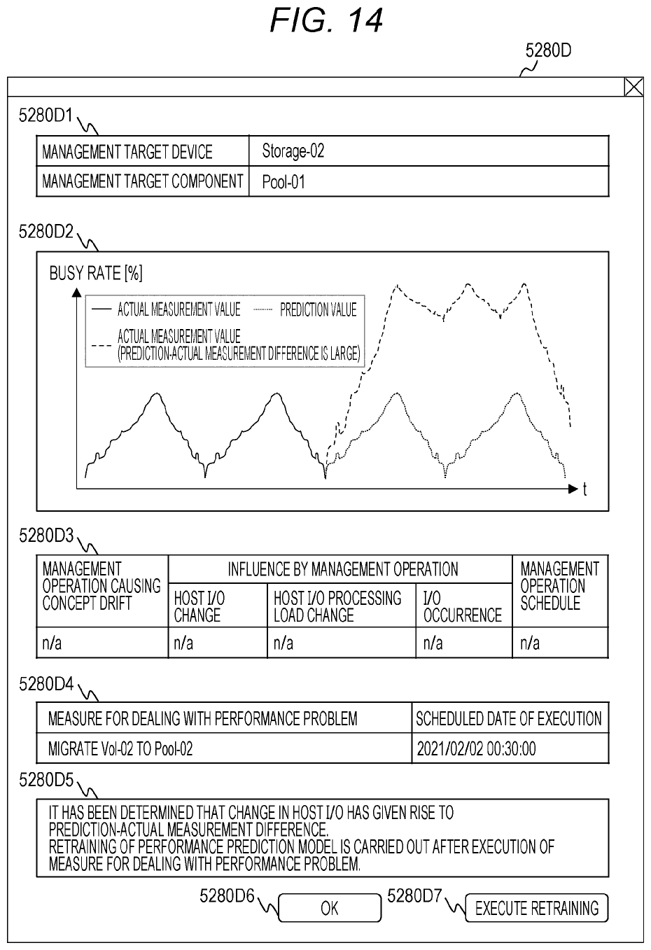

In the same manner as in FIG. 13, FIG. 14 shows a result of determination on whether retraining an ML model allocated to the storage capacity pool identified by “Pool-01” included in the storage array 4000 identified by “Storage-02”, as indicated in a management target display space 5280D1, is necessary. A management operation influence display space 5280D3 indicates that no management operation having caused a performance problem indicated by a prediction-actual measurement difference observed at the pool is present. In this case, in the retraining necessity determining process shown in FIG. 8, a determination result at step 20030 is “NO”, which gives a determination that retraining is necessary. A performance problem dealing measure space 5280D4 displays that as a measure for dealing with the performance problem indicated by the prediction-actual measurement difference, a management operation of transferring the storage capacity source for the volume identified by “Vol-02” to the storage capacity pool identified by “Pool-02” is scheduled to be executed at time “2021/02/02 00:30:00”. In this case, in the retraining necessity determining process of FIG. 8, a determination result at step 20110 is “YES”, so that a schedule is set for execution of retraining after completion of the management operation. Hence a retraining necessity determination result display space 5280D5 displays a determination result stating that because the performance problem indicated by the prediction-actual measurement difference has occurred due to a change in I/O from/to the computer 3000, i.e., host and volume migration is scheduled as a measure for dealing with the performance problem, the retraining necessity determining program 5280 determines that retraining of the ML model is executed after execution of the measure.

As described above, according to the computer system 100 of this embodiment, the management computer 5000 monitors metrics data on the computer 3000 and the storage array 4000, which are management targets, and determines whether a discrepancy, i.e., a concept drift larger than the threshold, exists between a result of prediction of a future value of the metrics data, the feature value being calculated by an ML model, and an actual measurement value of the metrics data. When determining that the concept drift exists, the management computer 5000 determines whether retraining the ML model is necessary, based on the table defining an influence a management operation exerts on the management target, on a log of management operations executed on the computer 3000 and the storage array 4000, and on a schedule of a management operation scheduled to be executed in future. When determining that retraining the ML model is necessary, the management computer 5000 determines whether execution of a management operation on a management target to be monitored using the ML model is scheduled, and when execution of the management operation is scheduled, sets a schedule for retraining the ML model after completion of the management operation. When executing retraining of the ML model, the management computer 5000 selects proper retraining data and then executes retraining of the ML model.

The management computer 5000 of this embodiment, therefore, is able to properly determine whether retraining of an ML model is necessary, according to a management operation having caused a concept drift, an influence the management operation exerts on a management target, and a management operation scheduled to be executed on the management target. This provides a method by which unnecessary retraining of the ML model is avoided and timing of executing retraining is optimized.

In this embodiment, the IT operation management system has been described as an example of a system utilizing the ML. The present invention, however, may be applied not only to the IT operation management system but also to other systems.

This embodiment includes the following items of features. It should be noted, however, that features included in this embodiment are not limited to the following items of features.

### (Item 1)

A management apparatus that includes a processor and a storage device, the management apparatus comprising:

a machine learning model generating unit that generates a machine learning model for inferring monitoring data acquired from a management target; an inference process unit that carries out an inference process using the machine learning model; a management unit that manages the management target using a result of the inference process; and

a retraining necessity determining unit that determines whether retraining the machine learning model is necessary, the machine learning model generating unit, the inference process unit, the management unit, and the retraining necessity determining unit being each provided by the processor's executing a software program stored in the storage device,

wherein

the management unit includes:

operation influence information defining an influence that a management operation on the management target exerts on the management target;

a management operation log recording a management operation executed on the management target; and

a management operation schedule indicating a management operation of which execution on the management target is planned or inferred, wherein the management unit determines whether a difference between actual measurement monitoring data that is monitoring data acquired from the management target and predicted monitoring data that is a result of an inference process of predicting the monitoring data, the inference process being executed by an inference process unit, exceeds a given threshold, and

the retraining necessity determining unit defines the difference as a significant difference when the difference exceeds the threshold, determines whether the significant difference is temporary or perpetual, based on the operation influence information, the management operation log, and the management operation schedule, and when determining the significant difference to be perpetual, determines that retraining of the machine learning model should be executed.

According to this item, when a significant difference arises between the actual measurement monitoring data and the predicted monitoring data, whether the significant difference is a temporary difference caused by a management operation or a perpetual difference that arises continuously is determined, and when the significant difference is perpetual one, it is determined that retraining of the machine learning model should be executed. This allows proper retraining of the machine learning model.

### (Item 2)

The management apparatus according to item 1, wherein

the management target is a computer system including one or more computers,

the operation influence information includes information defining an influence on data input/output between the one or more computers, and

the retraining necessity determining unit determines whether a management operation executed on the management target increases or decreases data input/output between the one or more computers; and when determining that the management operation increases or decreases the data input/output, determines that the significant difference is perpetual.

According to this item, whether retraining the machine learning model is necessary is determined by taking into consideration an influence on data input/output by the management operation in the computer system. This allows proper retraining of the machine learning model for carrying out an inference process on the computer system.

### (Item 3)

The management apparatus according to item 1, wherein

the management target is a computer system including one or more computers,

the operation influence information includes information defining an influence on processing load for processing data input/output between the one or more computers, and

the retraining necessity determining unit determines whether a management operation executed on the management target changes processing load that is applied to the computer as a result of data input/output between the one or more computers, and when determining that the management operation changes the processing load, determines that the significant difference is perpetual.

According to this item, whether retraining the machine learning model is necessary is determined by taking into consideration an influence on the processing load that is applied to the computer as a result of data input/output by a management operation in the computer system. This allows proper retraining of the machine learning model for carrying out an inference process on the computer system.

### (Item 4)

The management apparatus according to item 1, wherein

the management target is a computer system including one or more computers,

the operation influence information includes information that associates a type of a management operation with a determination on whether the management operation of the type causes data input/output to/from the one or more computers, and

the retraining necessity determining unit

determines whether a management operation executed on the management target is of a type that causes data input/output to/from the one or more computers, based on the management operation log,

when the management operation is of the type that causes data input/output to/from the one or more computers, the retraining necessity determining unit determines whether the management operation is executed continuously, based on the schedule, and

when determining that the management operation is executed continuously, the retraining necessity determining unit determines that the significant difference is perpetual.

According to this item, whether retraining the machine learning model is necessary is determined by taking into consideration an influence on the processing load that is applied to the computer as a result of data input/output by a management operation in the computer system. This allows proper retraining of the machine learning model for carrying out an inference process on the computer system.

### (Item 5)

The management apparatus according to item 1, wherein

when determining that retraining of the machine learning model should be executed, the retraining necessity determining unit determines whether execution of a management operation on the management target is scheduled, based on the management operation schedule, and

when execution of the management operation is scheduled, the retraining necessity determining unit does not allow retraining of the machine learning model until execution of the management operation is completed.

According to this item, when a management operation is scheduled at execution of retraining of the machine learning model, the retraining is executed after completion of the management operation. This reduces an influence by the management operation on the relearned machine learning model.

### (Item 6)

The management apparatus according to item 5, wherein the retraining necessity determining unit acquires actual measurement monitoring data from the management target, as post-management operation actual measurement monitoring data after execution of the scheduled management operation, determines whether a difference between the post-management operation actual measurement monitoring data and pre-significant difference occurrence actual measurement monitoring data that is actual measurement monitoring data acquired before occurrence of the significant difference exceeds a given threshold, and when the difference does not exceed the threshold, does not execute retraining of the machine learning model.

According to this item, when a management operation is scheduled at execution of retraining of the machine learning model, the retraining is executed after completion of the management operation. In a case where a significant difference is eliminated by a management operation for eliminating the significant difference, therefore, unnecessary execution of retraining can be prevented.

### (Item 7)

The management apparatus according to item 1, wherein when a management operation on the management target is executed, the management unit monitors a change that occurs at the management target after completion of the management operation, and updates the operation influence information, based on a change having occurred at the management target.

According to this item, the operation influence information can be updated in accordance with an actual situation that arises.

### (Item 8)

The management apparatus according to item 1, wherein the management unit specifies a management operation cyclically executed on the management target, as a cyclic management operation, based on the management operation log, predicts a time of execution of the cyclic management operation in future, based on the management operation log, and includes the cyclic management operation and the time of execution of the cyclic management operation in future in the management operation schedule.

According to this item, a cyclically executed management operation is reflected in the management operation schedule. This makes it possible to determine more correctly whether a significant difference is perpetual.

### (Item 9)

The management apparatus according to item 1, wherein when the retraining necessity determining unit determines that retraining of the machine learning model should be executed, the management unit uses monitoring data acquired after a time at which a management operation that is a cause for continuous occurrence of the significant difference is completed, as retraining data for retraining of the machine learning model, the monitoring data being among pieces of monitoring data acquired from the management target.

According to this item, the monitoring data acquired after completion of the management operation constituting the cause for the significant difference that occurs when it is determined that the machine learning model should be relearned is used as the retraining data. This allows generation of a machine learning model that reflects a new state after occurrence of the significant difference.

### (Item 10)

The management apparatus according to item 1, wherein when determining that the machine learning model should be relearned and finding that a second management operation is executed within a time at which retraining data used for retraining the machine learning model is acquired, the second management operation being different from a first management operation that is a cause for the perpetual significant difference, the retraining necessity determining unit corrects the retraining data in such a way as to exclude an influence by the second management operation from the retraining data and uses the corrected retraining data for the retraining.

According to this item, an influence by a different management operation is excluded from the retraining data. This allows generation of a machine learning model that reflects a continuous state.

### (Item 11)

The management apparatus according to item 1, further comprising a display unit that when the retraining necessity determining unit determines that the machine learning model should be relearned, displays information on grounds for a determination that the significant difference occurs continuously, based on the operation influence information, the management operation log, and the management operation schedule.

According to this item, information on grounds for a determination of execution of retraining is displayed so that grounds for the retraining can be known easily.

### (Item 12)

A management method executed by a computer that includes a processor and a storage device, the computer comprising:

a machine learning model generating unit that generates a machine learning model for inferring monitoring data acquired from a management target; an inference process unit that carries out an inference process using the machine learning model; a management unit that manages the management target using a result of the inference process; and

a retraining necessity determining unit that determines whether retraining the machine learning model is necessary, the machine learning model generating unit, the inference process unit, the management unit, and the retraining necessity determining unit being each provided by the processor's executing a software program stored in the storage device, the management method comprising:

causing the management unit to record operation influence information defining an influence that a management operation on the management target exerts on the management target, a management operation log recording a management operation executed on the management target, and

a management operation schedule indicating a management operation of which execution on the management target is planned or inferred;

causing the management unit to determine whether a difference between actual measurement monitoring data that is monitoring data acquired from the management target and predicted monitoring data that is a result of an inference process of predicting monitoring data, the inference process being executed by an inference process unit, exceeds a given threshold; and

causing the retraining necessity determining unit to define the difference as a significant difference when the difference exceeds the threshold, to determine whether the significant difference is temporary or perpetual, based on the operation influence information, the management operation log, and the management operation schedule, and when determining the significant difference to be perpetual, to determine that retraining of the machine learning model should be executed.

An apparatus and a method according to one aspect included in the present disclosure are applied preferably to a system operation management apparatus that continuously maintains and improves quality through operation of a system utilizing machine learning.

What is claimed is:

1. A management apparatus that includes a processor and a storage device, the management apparatus comprising:
a machine learning model generating unit that generates a machine learning model for inferring monitoring data acquired from a management target; an inference process unit that carries out an inference process using the machine learning model; a management unit that manages the management target using a result of the inference process; and
a retraining necessity determining unit that determines whether retraining the machine learning model is necessary, the machine learning model generating unit, the inference process unit, the management unit, and the retraining necessity determining unit being each provided by the processor's executing a software program stored in the storage device,
wherein
the management unit includes:
operation influence information defining an influence that a management operation on the management target exerts on the management target;
a management operation log recording a management operation executed on the management target; and
a management operation schedule indicating a management operation of which execution on the management target is planned or inferred, wherein the management unit determines whether a difference between actual measurement monitoring data that is monitoring data acquired from the management target and predicted monitoring data that is a result of an inference process of predicting monitoring data, the inference process being executed by an inference process unit, exceeds a given threshold, and
the retraining necessity determining unit defines the difference as a significant difference when the difference exceeds the threshold, determines whether the significant difference is temporary or perpetual, based on the operation influence information, the management operation log, and the management operation schedule, and when determining the significant difference to be perpetual, determines that retraining of the machine learning model should be executed.

2. The management apparatus according to claim 1, wherein
the management target is a computer system including one or more computers,
the operation influence information includes information defining an influence on data input/output between the one or more computers, and
the retraining necessity determining unit determines whether a management operation executed on the management target increases or decreases data input/output between the one or more computers; and when determining that the management operation increases or decreases the data input/output, determines that the significant difference is perpetual.

3. The management apparatus according to claim 1, wherein
the management target is a computer system including one or more computers,
the operation influence information includes information defining an influence on processing load for processing data input/output between the one or more computers, and
the retraining necessity determining unit determines whether a management operation executed on the management target changes processing load that is applied to the computer as a result of data input/output between the one or more computers, and when determining that the management operation changes the processing load, determines that the significant difference is perpetual.

4. The management apparatus according to claim 1, wherein
the management target is a computer system including one or more computers,
the operation influence information includes information that associates a type of a management operation with a determination on whether the management operation of the type causes data input/output to/from the one or more computers, and
the retraining necessity determining unit
determines whether a management operation executed on the management target is of a type that causes data input/output to/from the one or more computers, based on the management operation log,
when the management operation is of the type that causes data input/output to/from the one or more computers, the retraining necessity determining unit determines whether the management operation is executed continuously, based on the schedule, and
when determining that the management operation is executed continuously, the retraining necessity determining unit determines that the significant difference is perpetual.

5. The management apparatus according to claim 1, wherein
when determining that retraining of the machine learning model should be executed, the retraining necessity determining unit determines whether execution of a management operation on the management target is scheduled, based on the management operation schedule, and
when execution of the management operation is scheduled, the retraining necessity determining unit does not allow retraining of the machine learning model until execution of the management operation is completed.

6. The management apparatus according to claim 5, wherein the retraining necessity determining unit acquires actual measurement monitoring data from the management target, as post-management operation actual measurement monitoring data after execution of the scheduled management operation, determines whether a difference between the post-management operation actual measurement monitoring data and pre-significant difference occurrence actual measurement monitoring data that is actual measurement monitoring data acquired before occurrence of the significant difference exceeds a given threshold, and when the difference does not exceed the threshold, does not execute retraining of the machine learning model.

7. The management apparatus according to claim 1, wherein when a management operation on the management target is executed, the management unit monitors a change that occurs at the management target after completion of the management operation, and updates the operation influence information, based on a change having occurred at the management target.

8. The management apparatus according to claim 1, wherein the management unit specifies a management operation cyclically executed on the management target, as a cyclic management operation, based on the management operation log, predicts a time of execution of the cyclic management operation in future, based on the management operation log, and includes the cyclic management operation and the time of execution of the cyclic management operation in future in the management operation schedule.

9. The management apparatus according to claim 1, wherein when the retraining necessity determining unit determines that retraining of the machine learning model should be executed, the management unit uses monitoring data acquired after a time at which a management operation that is a cause for continuous occurrence of the significant difference is completed, as retraining data for retraining of the machine learning model, the monitoring data being among pieces of monitoring data acquired from the management target.

10. The management apparatus according to claim 1, wherein when determining that the machine learning model should be relearned and finding that a second management operation is executed within a time at which retraining data used for retraining the machine learning model is acquired, the second management operation being different from a first management operation that is a cause for the perpetual significant difference, the retraining necessity determining unit corrects the retraining data in such a way as to exclude an influence by the second management operation from the retraining data and uses the corrected retraining data for the retraining.

11. The management apparatus according to claim 1, further comprising a display unit that when the retraining necessity determining unit determines that the machine learning model should be relearned, displays information on grounds for a determination that the significant difference occurs continuously, based on the operation influence information, the management operation log, and the management operation schedule.

12. A management method executed by a computer that includes a processor and a storage device, the computer comprising:
a machine learning model generating unit that generates a machine learning model for inferring monitoring data acquired from a management target; an inference process unit that carries out an inference process using the machine learning model; a management unit that manages the management target using a result of the inference process; and
a retraining necessity determining unit that determines whether retraining the machine learning model is necessary, the machine learning model generating unit, the inference process unit, the management unit, and the retraining necessity determining unit being each provided by the processor's executing a software program stored in the storage device, the management method comprising:
causing the management unit to record operation influence information defining an influence that a management operation on the management target exerts on the management target, a management operation log recording a management operation executed on the management target, and
a management operation schedule indicating a management operation of which execution on the management target is planned or inferred;
causing the management unit to determine whether a difference between actual measurement monitoring data that is monitoring data acquired from the management target and predicted monitoring data that is a result of an inference process of predicting the monitoring data, the inference process being executed by an inference process unit, exceeds a given threshold; and
causing the retraining necessity determining unit to define the difference as a significant difference when the difference exceeds the threshold, to determine whether the significant difference is temporary or perpetual, based on the operation influence information, the management operation log, and the management operation schedule, and when determining the significant difference to be perpetual, to determine that retraining of the machine learning model should be executed.
